(19) United States
(12) Patent Application Publication
(10) Pub. No.: US 2004/0027826 A1
(43) Pub. Date: Feb. 12, 2004

(54) Lantern and utensil tree

(76) Inventor: Robert R. Walden, Wheat Ridge, CO (US)

Correspondence Address: Robert R. Walden DDS, 12375 W. 34th Place, Wheat Ridge, CO, 80033, US

(21) Appl. No.: 10/215,875

(22) Filed: Aug. 8, 2002

(51) Int. Cl. F21V 33/00; F21V 21/00

(52) U.S. Cl. 362/234; 362/431; 362/249

(57) ABSTRACT

A multi-part, lightweight, portable, multiple lantern and utensil support system is described. The system uses hollow body round tubular portions connected to one another by a series of slip-joints. The assembled structure supports one or two lanterns and various utensils at a distance above the ground. The insertion stake at the bottom of the assembly is pounded into the ground by use of a pounding tool. The pounding tool is also used to remove the stake and serve as the T on top of the pole for hanging the lanterns on hooks.

### BACKGROUND OF THE INVENTION

The invention relates to the field of stands and supports, specifically for portable lanterns and utensils used while camping. The lantern and utensil support assembly comes with a tool used to pound in and pull out of the ground the supporting base stake. The other parts of the assembly connect by slip-joints. I believe this invention to be a lightweight, compact support for one or two lanterns and multiple utensils.

There are hollow tube, lightweight lantern supports, but none are known from prior art to the inventor that will support multiple lanterns having sliding friction grip utensil supports and a tool included for pounding into and removing the stake from the ground. This tool also doubles as the lantern hanger that can have safety hooks.

See Golden, 10/96 and Kline, 12/76.

### BRIEF SUMMARY OF THE INVENTION

A lightweight, compact, multi-part support for one or two portable lanterns and multiple utensils at a distance above the ground is described. The system uses hollow tubular sections around two feet long that slip into one another. It also uses utensil hooks that slide freely on the vertical tubular portion and stay where they are placed by a friction fit. The stake at the bottom of the structure is pounded into and removed from the ground by the use of a tool designed for that purpose. This tool also doubles as the lantern hanger on top of the pole. This hanger can have safety hooks to keep the lantern from falling off the pole if it is bumped.

It is among the objects of this invention to provide a lightweight, portable, multiple lantern and utensil support that is easily and quickly assembled and disassembled into a compact package for storage and transport.

It is also among the objects of this invention to provide a support for two lanterns high enough above the ground (6′ to 8′) to more fully illuminate the camp area.

It is also among the objects of this invention to provide a tool used to easily pound in and pull out the stake from the ground. This tool also doubles as the lantern hanger on top of the assembled pole.

Other objectives of this invention will be readily apparent to those skilled in the art once the invention has been described.

### BRIEF DESCRIPTION OF THE SEVERAL VIEWS OF THE INVENTION

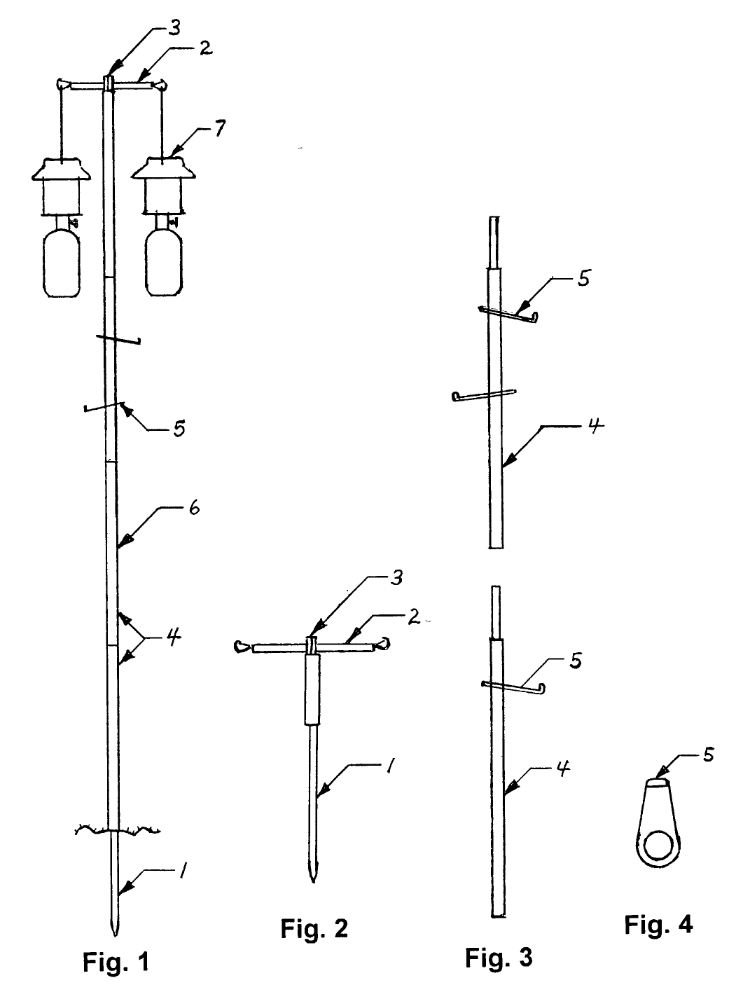

FIG. 1 Overall view of the invention.

FIG. 2 View of the stake with the pounding and pulling tool installed.

FIG. 3 Disassembled tubular sections.

FIG. 4 Sliding utensil hook.

### DETAILED DESCRIPTION OF THE INVENTION

The fully assembled lantern and utensil support tree is shown in FIG. 1. The pointed end of the stake 1 is pounded into and later pulled out of the ground by the tool 2 (see FIG. 2). The stake (approximately 18″ long) is pounded into the ground from 9 to 12 inches. The tool is either threaded onto the stake or attached by a pin through the sleeve 3 on the tool. The sleeve keeps the head of the stake from splaying or mushrooming since the tool is pounded on instead of the stake itself The tool is removed and the tube sections 4 are assembled over the stake in the ground with the sliding utensil hooks 5 (see FIG. 4) put on the pole 6. The pole is made up of the metal tube sections 4. The tube sections may be shock-corded together for ease of assembly to become the pole. The tool 2 then becomes the top structure. The tool/top structure is T-shaped with a hook on each end of the horizontal arm to hang the lanterns. These hooks can have safety snaps so that the lanterns 7 can't slip off accidentally if they are bumped. An additional tubular section 4 that is about one foot long can be added in above the stake to put the lanterns up even higher if necessary.

All of these parts, weighing a few pounds or less, can be stored in a bag approximately two feet long for ease of storage and transport.

What I claim is:

0001 The invention of a tool to prevent damage to the head of a stake being pounded into the ground, said tool having a horizontal member which acts as a handle to also easily remove the stake from the ground, with said tool also being used as the one or two lantern hanger bracket mounted on top of the support pole.

0002 The invention of a pole structure to hang two lanterns on safety snap hooks with friction hooks that freely slide and rotate on the vertical pole assembly to hang utensils and towels.
